(19) United States
(12) Patent Application Publication
(10) Pub. No.: US 2009/0179495 A1
(43) Pub. Date: Jul. 16, 2009

(54) Solar power supplying device

(76) Inventor: Ming-Hsiang Yeh, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,606

(22) Filed: Jan. 14, 2008

(51) Int. Cl. H02J 3/00; H02J 7/35; H02J 7/00; H02J 9/00

(52) U.S. Cl. 307/66; 320/101; 307/80

(57) ABSTRACT

A solar power supplying device includes a solar power collecting plate, a socket, an uninterruptible power supplying apparatus and an electric apparatus. The solar power collecting plate is used to absorb the solar power of sunlight and convert the solar power into a first power source. The socket is used to provide a second power source. The uninterruptible power supplying apparatus is provided with a built-in power source selector that is connected with the solar power collecting plate and the socket and is capable of selecting power inputs of the first power source and the second power source. An output end of the uninterruptible power supplying apparatus is combined with the electric appliance. The power source selector switches between the first power source and the second power source, thereby reducing the power source and cost.

### BACKGROUND OF THE INVENTION

1. Field of the Invention

The present invention relates to a solar power supplying device, and in particular to a solar power supplying device constituted of a solar power collecting plate, a socket, an uninterruptible power supplying apparatus, and an electric appliance. The uninterruptible power supplying apparatus is provided with a built-in power source selector that is capable of switching between a first power source and a second power source, thereby providing the electricity for the electric appliance without an additional power-accumulating element to store the electricity. Therefore, the power source, cost and space of the whole structure can be reduced, and thus it is suitable for a solar power supplying device or the like.

2. Description of Prior Art

With the advancement of the modern society and technologies, electric appliances have been available to common families and companies, and have become necessary products for them. The primary power of an electric appliance (such as a cooler, heater, electric fan etc.) is local electricity. Further, using the electric appliances frequently will consume a lot of power, increasing the expenditure of electricity fee. Thus, in view of the modern society short of power sources, it is not economic-effective to use the local electricity as the power source completely.

An alternative power supply is to use a solar power plate to provide electricity. However, the solar power plate has to be cooperated with a set of power-accumulating elements in order to provide electricity. The solar power of sunlight is absorbed by the solar power plate, converted into electricity and stored in the power-accumulating elements, so that electric appliances can use the generated electricity. However, in such a solar power plate, the power-accumulating elements are used to store the electricity, which may occupy additional space and also increase the cost.

Therefore, in view of the above drawbacks of prior art, the inventor of the present invention has proposed a novel and inventive structure based on his expert experience and researches.

### SUMMARY OF THE INVENTION

The primary object of the present invention is to provide a solar power supplying device that is constituted of a solar power collecting plate, a socket, an uninterruptible power supplying apparatus and an electric apparatus. The uninterruptible power supplying apparatus is provided with a built-in power source selector that is capable of switching between a first power source and a second power source, thereby providing the electricity for the electric appliance. Therefore, the power source and cost can be reduced, while the practicability of the whole structure can be increased.

Another object of the present invention is to provide a solar power supplying device. Since the solar power collecting plate provides electricity for the electric appliance directly without an additional power-accumulating element to store the electricity, it will not occupy addition space, thereby saving the space and increasing the practicability of the whole structure.

In order to achieve the above objects, the present invention provides a solar power supplying device, which includes a solar power collecting plate, a socket, an uninterruptible power supplying apparatus and an electric apparatus. The solar power collecting plate is used to absorb the solar power of sunlight and convert it into a first power source. The socket is used to provide a second power source. The uninterruptible power supplying apparatus is provided with a built-in power source selector that is connected with the solar power collecting plate and the socket and is capable of selecting power inputs of the first power source and the second power source. An output end of the uninterruptible power supplying apparatus is combined with the electric appliance, thereby increasing the practicability of the whole structure.

The other features and embodiments of the present invention can be further understood with reference to the detailed description thereof and the accompanying drawings.

### BRIEF DESCRIPTION OF THE DRAWINGS

FIG. 1 is a block view showing the system of the present invention;

FIG. 2 is a block view showing the system of another embodiment of the present invention;

FIG. 3 is a schematic view showing the operation of the present invention; and

FIG. 4 is a schematic view showing the detailed circuit in the power source selector of the present invention.

### DETAILED DESCRIPTION OF THE INVENTION

The present invention will be described with reference to specific embodiments thereof. However, it is apparent that other advantages and effects of the present invention may occur to those skilled in this art easily in view of the disclosure of the specification. The present invention can be implemented or carried out by means of other different embodiments. Each element recited in the specification can be modified and changed without departing from the spirit and scope of the present invention.

The aspect of the present invention will be further described with reference to the following embodiment. However, this embodiment is illustrative only but is not used to limit the present invention.

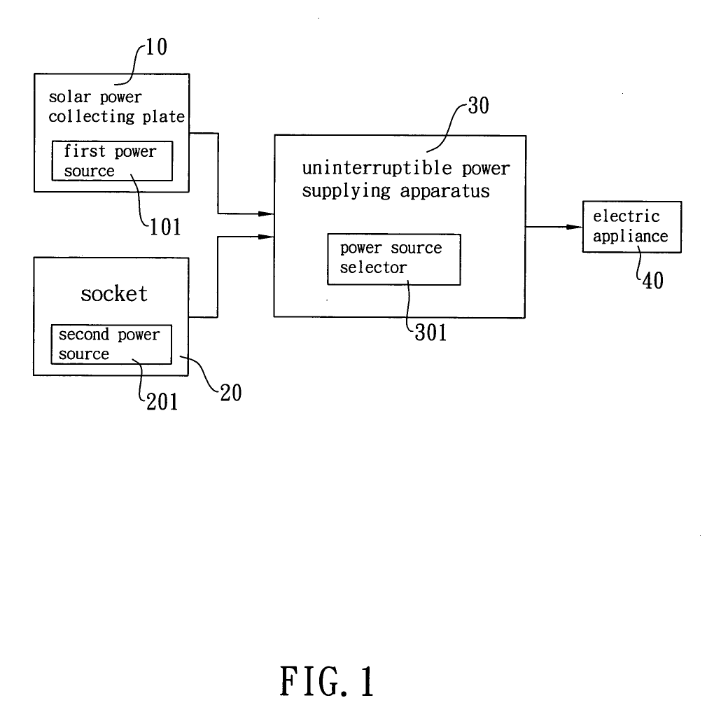

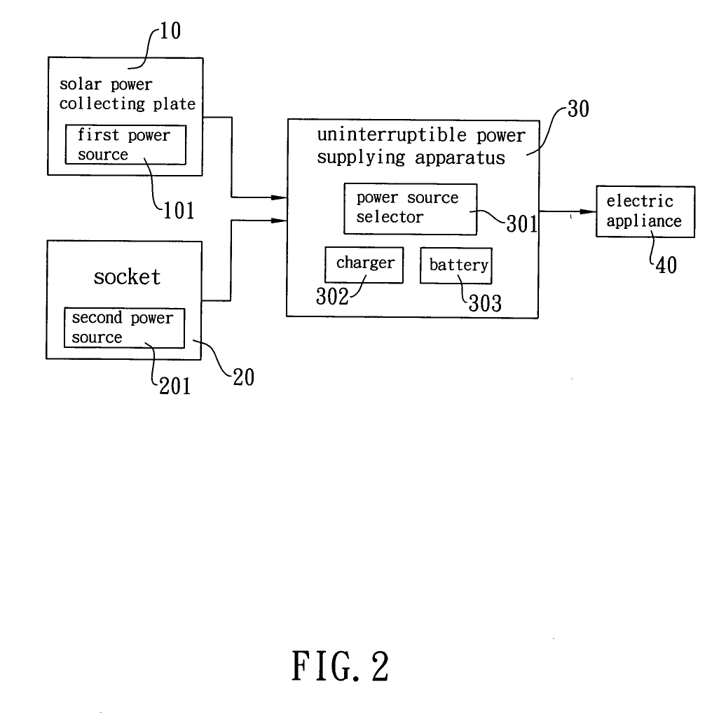

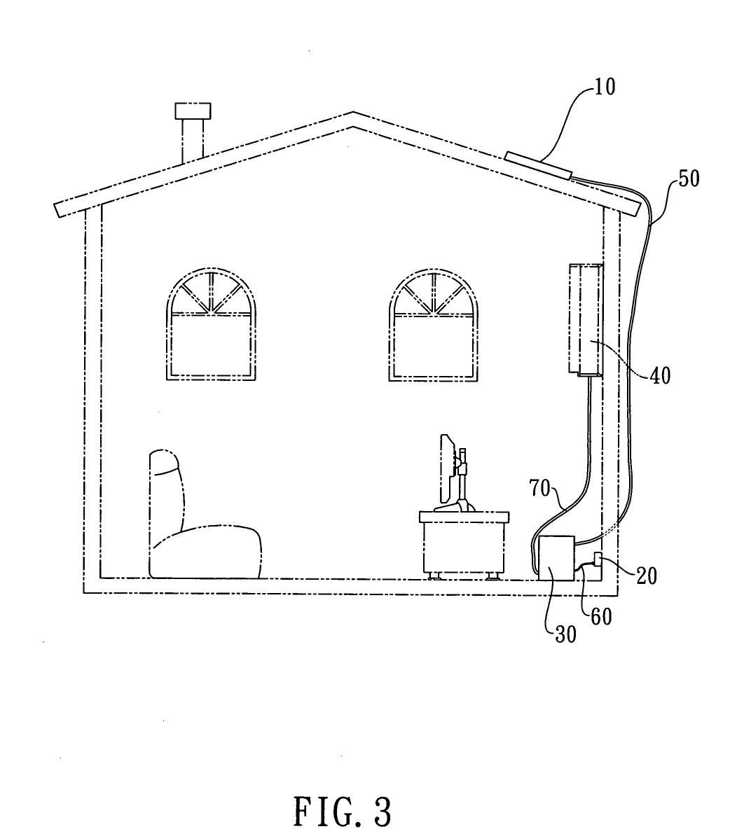

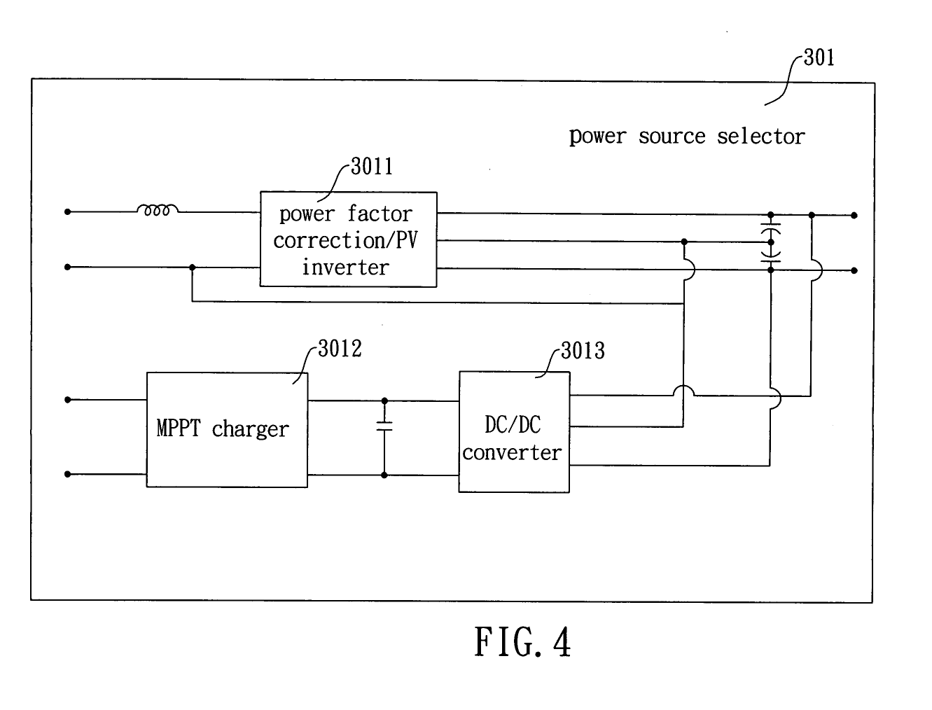

Please refer to FIGS. 1 to 4. FIG. 1 is a block view showing the system of the present invention. FIG. 2 is a block view showing the system of another embodiment of the present invention. FIG. 3 is a schematic view showing the operation of the present invention, and FIG. 4 is a schematic view showing the detailed circuit in the power source selector of the present invention. The present invention provides a solar power supplying device, which includes: a solar power collecting plate 10, a socket 20, an uninterruptible power supplying apparatus 30 and an electric appliance 40.

The solar power collecting plate 10 is used to absorb the solar power of sunlight and converts the solar power into a first power source 101. The first power source 101 is the solar power. The solar power collecting plate 10 is formed into a sheet-like body with or without flexibility. The solar power collecting plate 10 is provided outdoors and is connected to the indoor uninterruptible power supplying apparatus 30 directly via a first electric wire 50. The uninterruptible power supplying apparatus 30 can be also provided outdoors and is not limited to be provided indoors as shown in FIG. 3.

The socket 20 is used to provide a second power source 201. The second power source 201 is local electricity and is connected to the uninterruptible power supplying apparatus 30 via a second electric wire 60, thereby providing another power source for the electric appliance 40.

The uninterruptible power supplying apparatus 30 is provided with a built-in power source selector 301. The power source selector 301 is connected to the solar power collecting plate 10 and the socket 20. The power source selector 301 can be any one of software or hardware. The power source selector 301 is used to select power inputs of the first power source 101 and the second power source 201. Further, the power source selector 301 can utilize software to achieve the selection of power source. Alternatively, it can utilize hardware such as a relay, magnetic reed switch or motor to achieve the selection of power source. The power source selector 301 is provided with a power factor correction/PV inverter 3011, at least one MPPT charger 3012, and a DC/DC converter 3013. The MPPT charger 3012 is connected to the DC/DC converter 3013, and is then connected in parallel to the power factor correction/PV inverter 3011. The uninterruptible power supplying apparatus includes a charger 302 and a battery 303. An output end of the uninterruptible power supplying apparatus 30 is connected to the electric appliance 40 via a third electric wire 70. In the daytime, the solar power of sunlight is used to provide electricity. The MPPT charger 3012 will trace the solar power. If the electricity is insufficient, the first power source will be switched to the second power source 201 to provide electricity. Further, the power source selector 301 can control the distribution of the power sources via the software and hardware based on the user's demand, such as 80% of the input power of the first power source 101 (solar power collecting plate 10) and 20% of the input power of the second power source 201 (socket 20). Now matter whether the primary power source is interrupted or not, the present invention will find a second largest power or other generator to serve as the power source, and distribute the proportion and duration of the current of each power source based on the conditions of a user's plan. In ordinary times, the uninterruptible power supplying apparatus 30 stores the first power source 101 and the second power source 201, thereby serving as a spare power for the electric appliance 40 when the first power source 101 and the second power source 201 are interrupted at the same time.

The electric appliance 40 can be one of a cooler or a heater. It should be understood that although the electric appliance 40 of the present invention is exemplified as a cooler or heater, the present invention is not limited thereto. Any kinds of electric appliances 40 such as an electric fan, cold/hot water machine, electric boiler or the like can be used.

The solar power supplying device of the present invention is characterized by consisting of the solar power collecting plate 10, the socket 20, the uninterruptible power supplying apparatus 30 and the electric appliance 40. The power source selector 301 that is built in the uninterruptible power supplying apparatus 30 can switch between the first power source 101 and the second power source 201 (also distributes the power inputs of the first power source 101 and the second power source 201 according to the user's plan), thereby providing electricity for the electric appliance 40. For example, in the daytime, the first power source 101 can be used to provide electricity for the electric appliance 40. At night, the second power source 201 can be used to provide electricity for the electric appliance 40. Thus, it is unnecessary to provide an additional power-accumulating element to store electricity, so that no additional space will be occupied. Therefore, the power source, cost and space is reduced while the practicability and convenience of the whole structure is increased.

According to the above, the present invention already achieves the desired objects and solves the drawbacks of prior art. Further, the present invention really has novelty and inventive steps. Therefore, the present invention conforms to the requirements for a utility model patent.

What is claimed is:

1. A solar power supplying device, comprising:
a solar power collecting plate for absorbing the solar power of sunlight and converting the solar power into a first power source;
a socket for providing a second power source; and
an uninterruptible power supplying apparatus provided with a built-in power source selector, the power source selector being connected to the solar power collecting plate and the socket for selecting power inputs of the first power source and the second power source, an output end of the uninterruptible power supplying apparatus being combined with an electric appliance.

2. The solar power supplying device according to claim 1, wherein the solar power collecting plate is formed into a sheet-like body.

3. The solar power supplying device according to claim 1, wherein the second power source is local electricity.

4. The solar power supplying device according to claim 1, wherein the power source selector is software for selecting the power inputs of the first power source and the second power source.

5. The solar power supplying device according to claim 1, wherein the power source selector is hardware for selecting the power inputs of the first power source and the second power source.

6. The solar power supplying device according to claim 5, wherein the hardware is any one of a relay, a magnetic reed switch and a motor.

7. The solar power supplying device according to claim 1, wherein the electric appliance is any one of a cooler and a heater.

8. The solar power supplying device according to claim 1, wherein the power source selector is provided with a power factor correction/PV inverter, at least one MPPT charger and a DC/DC converter, the MPPT charger is connected to the DC/DC converter and is connected in parallel to the power factor correction/PV inverter.

9. The solar power supplying device according to claim 1, wherein the uninterruptible power supplying apparatus includes a charger and a battery.

10. The solar power supplying device according to claim 1, wherein the power source selector further controls and distributes the power inputs of the first power source and the second power source.

11. The solar power supplying device according to claim 4, wherein the power source selector further controls and distributes the power inputs of the first power source and the second power source.

12. The solar power supplying device according to claim 5, wherein the power source selector further controls and distributes the power inputs of the first power source and the second power source.
